(19) United States
(12) Patent Application Publication
(10) Pub. No.: US 2021/0027724 A1
(43) Pub. Date: Jan. 28, 2021

(54) VIDEO PROCESSER, DISPLAY DEVICE, METHOD OF VIDEO PROCESSING, AND RECORDING MEDIUM

(71) Applicant: SHARP KABUSHIKI KAISHA, Sakai City, Osaka (JP)

(72) Inventors: TAKAYUKI MURAI, Sakai City, Osaka (JP); RYOJI SAKURAI, Sakai City, Osaka (JP); KAZUYOSHI YOSHIYAMA, Sakai City, Osaka (JP)

(21) Appl. No.: 16/968,997

(22) PCT Filed: Feb. 25, 2019
(86) PCT No.: PCT/JP2019/007131

§ 371 Date: Aug. 11, 2020

(30) Foreign Application Priority Data
Feb. 26, 2018 (JP) 2018-032325

(51) Int. Cl. G09G 3/34

(52) U.S. Cl. CPC G09G 3/3426; G09G 2320/0666; G09G 2320/0686

(57) ABSTRACT

A video processor included in a display device that includes a backlight having a plurality of divided regions, the video processor including: a first video processing unit configured to perform video processing on a partial video region that is a partial region of an input video; and a second video processing unit configured to perform video processing on a region different from the partial video region, wherein the first video processing unit transmits control data for controlling the plurality of divided regions of the backlight to the backlight, and the plurality of divided regions of the backlight controlled by the control data, which is transmitted by the first video processing unit, and the plurality of divided regions of the backlight corresponding to the partial video region, which is processed by the first video processing unit, are different from each other.

### TECHNICAL FIELD

The present disclosure relates to a video processor and other things.

### BACKGROUND ART

Patent Document 1 discloses an exemplary video processor that performs processing, such as color-tone correction, on video data that is input.

### CITATION LIST

### Patent Literature

Patent Document 1: Japanese Patent Application Laid-Open No. 2016-184775 (published on Oct. 20, 2016)

### SUMMARY OF INVENTION

### Technical Problem

For a large amount of video data exceeding the processing capability of the video processor, the video processor divides the input video into multiple regions, and multiple video processors perform processing on the respective regions. When the video processor performs local dimming in this case, the video processors output backlight control data for controlling regions of a backlight corresponding to their respective target regions. This requires an additional function of integrating together the backlight control data, output from the video processors, thus increasing the costs for manufacturing the video processor.

It is an object of one aspect of the present disclosure to achieve a cost-saving video processor.

### Solution to Problem

To solve the above problem, one aspect of the present disclosure is directed to a video processor included in a display device that includes a backlight having a plurality of divided regions. The video processor includes a first video processing unit that performs video processing on a partial video region that is a partial region of an input video. The video processor also includes a second video processing unit that performs video processing on a region different from the partial video region. The first video processing unit transmits control data for controlling the plurality of divided regions of the backlight to the backlight. The plurality of divided regions of the backlight controlled by the control data, which is transmitted by the first video processing unit, and the plurality of divided regions of the backlight corresponding to the partial video region, which is processed by the first video processing unit, are different from each other.

Another aspect of the present disclosure is directed to a method of video processing performed in a video processor included in a display device that includes a backlight having a plurality of divided regions. The video processor includes a first video processing unit that performs video processing on a partial video region that is a partial region of an input video. The video processor also includes a second video processing unit that performs video processing on a region different from the partial video region. The method includes the steps of: performing, in the first video processing unit, video processing on the partial video region and performing, in the second video processing unit, video processing on the region different from the partial video region; and transmitting control data for controlling the plurality of divided regions of the backlight to the backlight. The transmitting step is performed in the first video processing unit. The plurality of divided regions of the backlight controlled by the control data, which is transmitted by the first video processing unit, and the plurality of divided regions of the backlight corresponding to the partial video region, which is processed by the first video processing unit, are different from each other.

### Advantageous Effect of Invention

The video processor and method of video processing according to the aspects of the present disclosure can save the costs for manufacturing the video processor.

### BRIEF DESCRIPTION OF DRAWINGS

FIG. 1 is a block diagram illustrating the configuration of main components of a display device according to a first embodiment.

FIG. 2 is a block diagram illustrating the configuration of the display device according to the first embodiment.

FIG. 3 is a flowchart of a process performed in first and second video processing units.

FIG. 4 is a diagram of local dimming performed in a comparative display device.

FIG. 5 is a diagram of local dimming performed in the display device according to the first embodiment.

FIG. 6(a) illustrates an exemplary input video; FIG. 6(b) illustrates a first region of the input video; FIG. 6(c) illustrates control data that is calculated by a control-data calculator; FIG. 6(d) illustrates a second region of the input video; FIG. 6(e) illustrates control data that is calculated by the control-data calculator; FIG. 6(f) illustrates the diffusion of LED brightness; and FIG. 6(g) illustrates brightness distribution data that is based on only the LED brightness of the first region; and FIG. 6(h) illustrates brightness distribution data that is based on only the LED brightness of the second region.

FIG. 7 is a block diagram illustrating the configuration of a display device according to a second embodiment.

FIG. 8(a) illustrates an exemplary substrate arrangement in the display device according to the first embodiment; FIG. 8(b) illustrates an exemplary configuration of a display device that includes a backlight having an increased number of divided regions; FIG. 8(c) illustrates an exemplary substrate arrangement of the display device according to the second embodiment; and FIG. 8(d) illustrates an exemplary substrate arrangement of a display device according to a modification of the second embodiment.

FIG. 9(a) illustrates exemplary wiring in the display device illustrated in FIG. 8(d); and FIG. 9(b) illustrates different exemplary wiring in in the display device illustrated in FIG. 8(d).

FIG. 10 is a diagram illustrating the configuration of a display device according to a third embodiment.

FIG. 11 is a diagram illustrating the configuration of main components of a display device according to a fourth embodiment.

FIG. 12 is a diagram illustrating the configuration of main components of a display device according to a fifth embodiment.

FIG. 13 is a diagram illustrating the configuration of main components of a display device according to a sixth embodiment.

### DESCRIPTION OF EMBODIMENTS

### First Embodiment

The following details a display device 1 (i.e., a video processor) according to an embodiment of the present disclosure. The display device 1 generates an output video to be displayed by the display device 1, and it displays the output video. For convenience in description, components in the subsequent embodiments whose functions are the same as components described in the first embodiment will be denoted by the same signs and will not be elaborated upon.

The display device 1 displays a single 8K4K video (i.e., a video of 8K4K resolution). Resolution 8K4K means a resolution of 7680 horizontal pixels×4320 vertical pixels. The resolution 8K4K can be just referred to as 8K.

Resolution 4K2K means a resolution of 3840 horizontal pixels×2160 vertical pixels. A single 8K4K video can be expressed as a video consisting of four (i.e., two in the horizontal direction and two in the vertical direction) 4K2K videos (i.e., a video of 4K2K resolution). That is, a single 8K4K video can be expressed by combining four 4K2K videos. The resolution 4K2K can be just referred to as 4K.

Resolution 4K4K means a resolution of 3840 horizontal pixels×4320 vertical pixels. A single 4K4K video (i.e., a video of 4K4K resolution) can be expressed by arranging two 4K2K videos vertically. Moreover, a single 8K4K video can be expressed by arranging two 4K4K videos horizontally.

The following description deals with an input video consisting of four regions (i.e., divided video regions) A, B, C, and D. To be specific, let the input video be divided into two regions vertically and two regions horizontally. Accordingly, the region A is in the upper-left part of the input video; the region B, the upper-right part of the same; the region C, the lower-left part of the same; and the region D, the lower-right part of the same. In the following description, the input video is divided into the regions A to D or into combined regions of them. In the following description, the input video has a resolution of 8K, and the regions A to D each have a resolution of 4K.

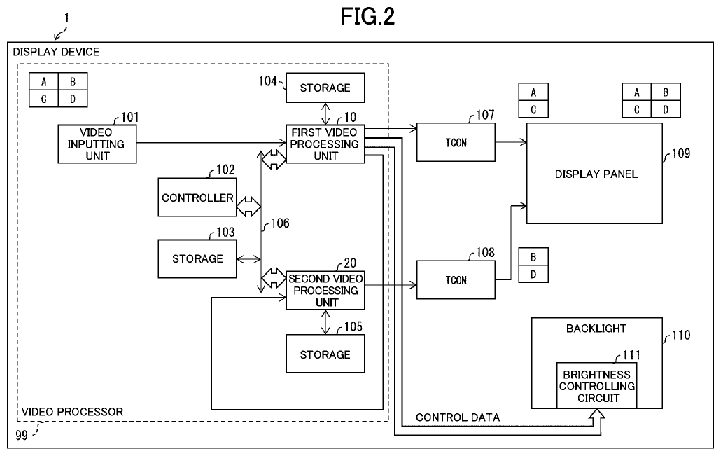

FIG. 2 is a block diagram illustrating the configuration of the display device 1 according to this embodiment. As illustrated in FIG. 2, the display device 1 includes a display panel 109, a backlight 110, and a video processor 99. The video processor 99 includes a first video processing unit 10, a second video processing unit 20, a video inputting unit 101, a controller 102, a storage 103, and storages 104 and 105, as illustrated in FIG. 2, a broken-line portion. It is noted that the controller 102, storage 103, and storages 104 and 105 may be located outside the video processor 99. The display device 1 further includes a bus 106 and timing controllers (hereinafter abbreviated as TCONs) 107 and 108.

The first video processing unit 10 and the second video processing unit 20 perform video processing on partial video regions, which are partial regions of the input video. In this embodiment, the first video processing unit 10 processes the regions A and C, and the second video processing unit 20 processes the regions B and D. That is, the first video processing unit 10 performs the video processing on partial video regions, which are partial regions of the input video, and the second video processing unit 20 performs the video processing on regions different from the partial video regions processed by the first video processing unit 10. To be specific, each of the first video processing unit 10 and the second video processing unit 20 generates control data about its target partial video regions. The control data is used for controlling divided regions of the backlight 110 corresponding to the partial video regions.

The bold arrow in FIG. 2 denotes a flow of the control data. As illustrated in FIG. 2, the first video processing unit 10 and the second video processing unit 20 mutually transmit and receive the calculated control data via the bus 106 and controller 102. Furthermore, the first video processing unit 10 transmits the control data to the backlight 110. The configuration of the first video processing unit 10 and second video processing unit 20 will be detailed later on.

The video inputting unit 101 transmits a video signal of the input video to the first video processing unit 10. That is, the first video processing unit 10 receives both data of the left half of the input video and data of the right half of the same from the video inputting unit 101. The first video processing unit 10 further transmits the data of the right-half region of the input video to the second video processing unit 20. Accordingly, the first video processing unit 10 can process the left-half region of the input video, and the second video processing unit 20 can process the right-half region of the same.

It is noted that the video inputting unit 101 may include a video divider (not shown) that divides the input video into right and left halves so as to transmit the pieces of video data of their target regions to the respective first video processing unit 10 and second video processing unit 20. The video inputting unit 101 in this case inputs the data of the left half of the input video to the first video processing unit 10 and inputs the data of the right half of the same to the second video processing unit 20.

It is also noted that the video inputting unit 101 may transmit a video signal of the entire input video to each of the first video processing unit 10 and the second video processing unit 20. The first video processing unit 10 and the second video processing unit 20 in this case process their respective half regions of the input video and abandons the video signal of their non-target regions.

The controller 102 controls the operation of the display device 1 centrally. In this embodiment, the controller 102 is connected to the first video processing unit 10, the second video processing unit 20, and the storages 103 to 105 via the bus 106.

The storages 103, 104, and 105 respectively store data about control in the controller 102, data about control in the first video processing unit 10, and data about control in the second video processing unit 20. The storages 104 and 105 store, for instance, control data for controlling the brightness of LEDs included in the backlight 110, which will be described later on.

The TCON 107 acquires display data that is displayed on the display panel 109 from the first video processing unit 10. Likewise, the TCON 108 acquires display data from the second video processing unit 20. The TCONs 107 and 108 convert the format of their acquired display data in conformance with the display on the display panel 109. The TCONs 107 and 108 further transmit the display data after format conversion to the display panel 109.

The display panel 109 displays an output video based on the display data received from the TCONs 107 and 108. In this embodiment, the display device 1 includes a liquid-crystal panel, which is herein the display panel 109. The display panel 109 has multiple pixels (not shown) and a display controller (not shown) that controls the transmittance of light in the pixels on the basis of the display data. The backlight 110 includes multiple light-emitting units (not shown) that cast light upon the display panel 109. In this embodiment, the backlight 110 includes light-emitting diodes (LEDs), which are herein the light-emitting units. The display controller controls the transmittance indicating how much the light from the backlight 110 transmits through the pixels, so that the display device 1 displays the output video.

The backlight 110 has multiple divided regions. To be specific, the backlight 110 has regions corresponding to the respective regions A to D of the foregoing input video. In the following description, these regions of the backlight 110 can be also referred to as regions A to D. The backlight 110 includes multiple light-emitting units, which cast light upon the display panel. In this embodiment, the backlight 110 includes multiple LEDs belonging to any of the regions A to D. The backlight 110 also includes a brightness controlling circuit 111 that drives the LEDs. In other words, the brightness controlling circuit 111 controls the brightness of each of the regions A to D.

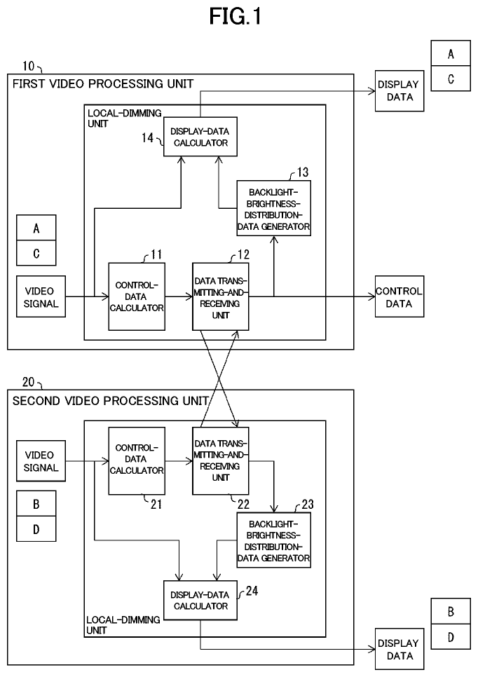

FIG. 1 is a block diagram illustrating the configuration of main components of the display device 1. To be specific, FIG. 1 illustrates the configuration of the first video processing unit 10 and second video processing unit 20 of the display device 1.

The first video processing unit 10 includes a control-data calculator 11, a data transmitting-and-receiving unit 12, a backlight-brightness-distribution-data generator 13, and a display-data calculator 14. Likewise, the second video processing unit 20 includes a control-data calculator 21, a data transmitting-and-receiving unit 22, a backlight-brightness-distribution-data generator 23, and a display-data calculator 24.

Based on the signal of the regions A and C of the input video, the control-data calculator 11 generates control data for controlling the LEDs included in the regions A and C of the backlight 110. Likewise, based on the signal of the regions B and D of the input video, the control-data calculator 21 generates control data for controlling the LEDs included in the regions B and D of the backlight 110.

The data transmitting-and-receiving units 12 and 22 mutually transmit and receive the control data generated by the control-data calculator 11 and 21. Accordingly, each of the first video processing unit 10 and the second video processing unit 20 acquires control data corresponding to the entire input video. To be specific, the data transmitting-and-receiving units 12 and 22 mutually transmit and receive the control data via the controller 102, as illustrated in FIG. 2. The transmitted and received data pieces are stored in the respective storages 104 and 105.

As illustrated in FIG. 2, the data transmitting-and-receiving unit 12 transmits control data for controlling all the divided regions of the backlight 110 to the brightness controlling circuit 111. That is, the first video processing unit 10 transmits this control data to the brightness controlling circuit 111. Consequently, the divided regions of the backlight 110 controlled by the control data transmitted by the first video processing unit 10 (i.e., regions corresponding to the regions A to D) and the divided regions of the backlight 110 corresponding to the partial video regions (i.e., regions corresponding to the regions A and C) that are target regions for the first video processing unit 10 are different from each other.

The data transmitting-and-receiving unit 22 at this time does not transmit the control data to the brightness controlling circuit 111. In some embodiments, the display device 1 may be configured such that the data transmitting-and-receiving unit 22 transmits the control data to the brightness controlling circuit 111, and the data transmitting-and-receiving unit 12 does not transmit the control data to the brightness controlling circuit 111. That is, the first video processing unit 10 or the second video processing unit transmits the above control data to the brightness controlling circuit.

Based on the control data for controlling the LEDs included in the regions of the backlight 110 corresponding to the entire video signal, the backlight-brightness-distribution-data generator 13 generates backlight-brightness distribution data for the regions A and C. The backlight-brightness-distribution-data generator 13 at this time refers to control data for controlling (i) the LEDs that are included in the regions of the backlight 110 corresponding to the regions A and C, and (ii) the LEDs that are not included in the regions of the backlight 110 corresponding to the regions A and C and that affect the brightness of the backlight 110 in the regions A and C. The backlight-brightness-distribution-data generator 13 can consequently generate backlight-brightness distribution data that is closer to the actual brightness distribution than backlight-brightness distribution data that is generated by referring to only the control data for controlling the LEDs included in the regions A and C of the backlight 110.

Likewise, based on the control data for controlling the LEDs included in the regions of the backlight 110 corresponding to the entire video signal, the backlight-brightness-distribution-data generator 23 generates backlight-brightness distribution data for the regions B and D. The backlight-brightness-distribution-data generator 23 at this time refers to control data for controlling (i) the LEDs that are included in the regions of the backlight 110 corresponding to the regions B and D, and (ii) the LEDs that are not included in the regions of the backlight 110 corresponding to the regions B and D and that affect the brightness of the backlight 110 in the regions B and D. The backlight-brightness-distribution-data generator 23 can consequently generate backlight-brightness distribution data that is closer to the actual brightness distribution than backlight-brightness distribution data that is generated by referring to only the control data for controlling the LEDs included in the regions B and D of the backlight 110.

The display-data calculator 14 refers to the backlight-brightness distribution data generated by the backlight-brightness-distribution-data generator 13 and then generates display data for regions of the output video corresponding to the regions A and C. The display data is a brightness value of each pixel in the output video. Likewise, the display-data calculator 24 refers to the backlight-brightness distribution data generated by the backlight-brightness-distribution-data generator 23 and then generates display data for regions of the output video corresponding to the regions B and D.

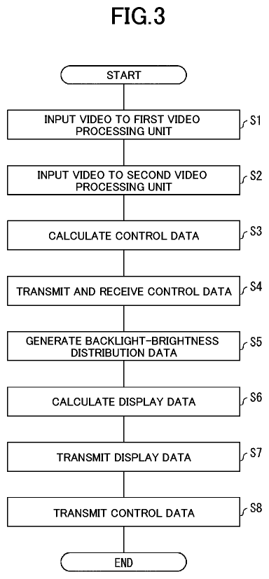

FIG. 3 is a flowchart showing how the first video processing unit 10 and the second video processing unit 20 perform video processing. With reference to FIG. 3, the process in the first video processing unit 10 and second video processing unit 20 will be described.

In Step S1, the video inputting unit 101 first inputs a signal for the regions A to D of the input video to the first video processing unit 10. In Step S2, the first video processing unit 10 next inputs a signal for the regions B and D of the input video to the second video processing unit 20.

In Step S3, a step of generating control data, each of the first video processing unit 10 and the second video processing unit 20 then calculates control data about its target divided video regions. This control data is used for controlling divided regions of the backlight 110 corresponding to these divided video regions. To be specific, the control-data calculator 11 in the first video processing unit 10 calculates control data about a region of the backlight 110 corresponding to the regions A and C. In parallel, the control-data calculator 21 in the second video processing unit 20 calculates control data about a region of the backlight 110 corresponding to the regions B and D. In Step S4, a step of transmission and reception, the data transmitting-and-receiving units 12 and 22 mutually transmit and receive the pieces of control data calculated by the respective control-data calculator 11 and 21.

In Step S5, the backlight-brightness-distribution-data generators 13 and 23 generate backlight-brightness distribution data for a region of the backlight 110 corresponding to the entire input video. In Step S6, a step of video processing, each of the display-data calculators 14 and 24 performs video processing on its target partial video region. To be specific, each of the display-data calculators 14 and 24 calculates, for its target partial video region, display data with the backlight-brightness-distribution data reflected. In Step S7, the display-data calculators 14 and 24 then transmit their calculated pieces of display data to the display panel 109. In Step S8, a step of control-data transmission, the data transmitting-and-receiving unit 12 further transmits control data for controlling all the divided regions of the backlight 110 to the brightness controlling circuit 51.

Through these process steps, the pieces of display data for displaying the output video and the piece of control data are respectively transmitted to the display panel 109 and the backlight 110. It is noted that Step 8 does not necessary have to be executed after Step S7 and may be executed at any timing after Step S4.

Accuracy Improvement in Local Dimming

The following describes the accuracy of local dimming in the display device 1. The following description deals with an instance where the backlight 110 is divided into 32×16 areas and where brightness is controllable for each area. In the following description, regions of the input video that are targets for the first video processing unit 10 and regions of the backlight 110 and output video corresponding to these target regions are referred to as a first region. In addition, regions of the input video that are targets for the second video processing unit 20 and regions of the backlight 110 and output video corresponding to these target regions are referred to as a second region. The first region corresponds to the regions A and C, and the second region corresponds to the regions B and D. Moreover, the first and second regions are each divided into areas of 16×16 in the backlight 110.

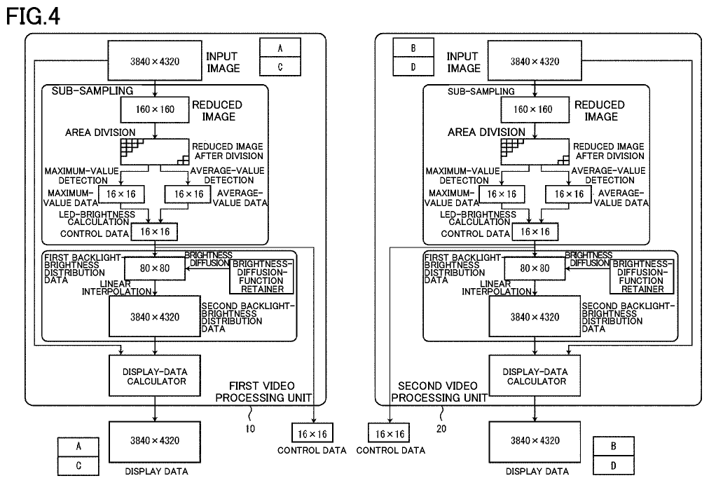

FIG. 4 is a diagram illustrating local dimming in a comparative display device. First, the local dimming in the comparative display device will be described. The comparative display device is different from the display device 1 in that a video processing unit that processes the first region and a video processing unit that processes the second region do not mutually transmit and receive control data. In the following description and FIG. 4, the video processing units of the comparative display device are referred to as a first video processing 10 and a second video processing 20 as well for convenience.

As illustrated in FIG. 4, each of the first video processing unit 10 and the second video processing unit 20 performs sub-sampling on an input image having a brightness of 3840×4320 pixels, to obtain a reduced image having a brightness of 160×160 pixels. The reduced image is divided into 16×16 areas (with an area size of 10×10 pixels). Calculating the maximum and average values of the pixel brightness for each area obtains maximum-value data including the maximum value of the 16×16 areas and obtain average-value data including the average value of the 16×16 areas. Then, based on any of (i) the maximum-value data, (ii) the average-value data, and (iii) the weighted average of the maximum-value data and average-value data, control data indicating the LED brightness of the 16×16 areas is calculated.

Applying brightness diffusion filtering to the control data obtains first backlight-brightness distribution data including a display brightness of 80×80 pixels. Applying correction filtering to the first backlight-brightness distribution data corrects the display brightness included in the first backlight-brightness distribution data. Performing linear interpolation on the first backlight-brightness distribution data obtains second backlight-brightness distribution data including a display brightness of 3840×4320 pixels, that is, the brightness distribution data of the backlight 110. Finally, dividing the brightness of the pixels included in the input image by the display brightness included in the brightness distribution data obtains display data for 3840×4320 pixels.

In the comparative display device, the first video processing unit 10 and the second video processing unit 20 do not mutually transmit and receive the control data. Hence in the comparative display device, each of the first video processing unit 10 and the second video processing unit 20 calculates the brightness distribution data on the basis of only the control data about its target 16×16 areas. The accuracy of the brightness distribution data degrades in this case, thereby possibly lowering the accuracy of the local dimming per se. The details will be described later on.

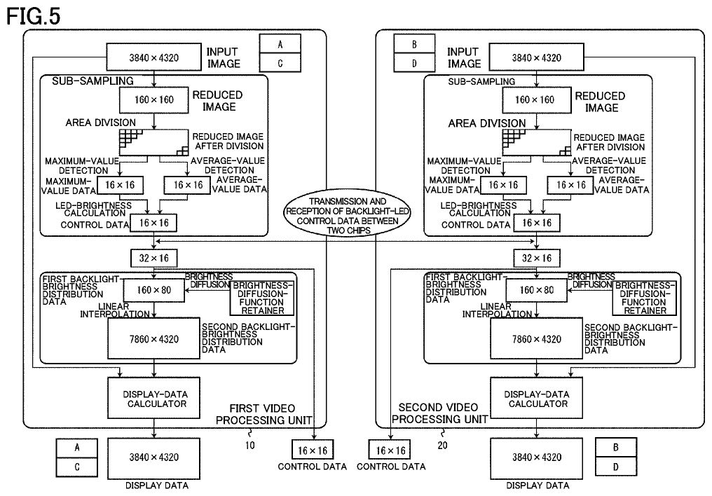

FIG. 5 is a diagram illustrating local dimming in the display device 1. Next, the local dimming in the display device 1 will be described. Before the calculation of control data, the first video processing unit 10 and second video processing unit 20 of the display device 1 perform process steps similar to those in the first video processing unit 10 and second video processing unit 20 of the comparative display device. As illustrated in FIG. 5, the first video processing unit 10 and second video processing unit 20 of the display device 1 mutually transmit and receive the control data after each unit calculates the control data about the 16×16 areas. Consequently, the first video processing unit 10 and the second video processing unit 20 each hold LED control data about the 32×16 areas. In each of the first video processing unit 10 and the second video processing unit 20 accordingly, applying brightness diffusion filtering to the control data about the 32×16 areas obtains first backlight-brightness distribution data including a display brightness of 160×80 pixels. Applying correction filtering to the first backlight-brightness distribution data, followed by linear interpolation obtains second backlight-brightness distribution data (i.e., brightness distribution data) including a display brightness of 7860×4320 pixels. Finally, dividing the brightness of the pixels included in the input image by the display brightness included in the brightness distribution data obtains display data. There are at this time 3840×4320 pixels included in the image that is input to each of the first video processing unit 10 and the second video processing unit 20. The display data obtained in each of the first video processing unit 10 and the second video processing unit 20 thus has a size of 3840×4320 pixels as well.

It is noted that in the display device 1, each reduced image, obtained through the sub-sampling, is not limited to a reduced image having a brightness of 160×160 pixels. It is also noted that the first backlight-brightness distribution data is not limited to backlight-brightness distribution data having a display brightness of 160×80 pixels.

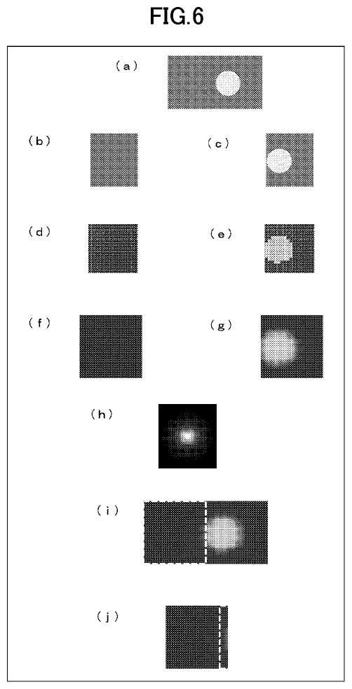

FIG. 6(a) illustrates an exemplary input video. FIG. 6(b) illustrates the first region of the input video. FIG. 6(c) illustrates the control data calculated by the control-data calculator 11. FIG. 6(d) illustrates the second region of the input video. FIG. 6(e) illustrates the control data calculated by the control-data calculator 21. FIG. 6(f) illustrates the diffusion of the LED brightness. FIG. 6(g) illustrates the brightness distribution data based on only the LED brightness in the first region. FIG. 6(h) illustrates the brightness distribution data based on only the LED brightness in the second region.

The input video illustrated in FIG. 6(a) is a video where there is a bright region in the second region, near the boundary between the first and second regions, and the rest of the video is a dark region. Thus, the first region is a video that is a dark region in its entirety, as illustrated in FIG. 6(b). The control-data calculator 11 accordingly calculates control data for controlling the LED brightness at low level in the entire first region of the backlight 110, as illustrated in FIG. 6(c).

As illustrated in FIG. 6(d), the second region is a video having a bright region near the first region. The control-data calculator 21 accordingly calculates control data for controlling the LED brightness at high level in a region included in the second region of the backlight 110 and corresponding to the bright region, as illustrated in FIG. 6(e).

When the first video processing unit 10 and the second video processing unit 20 do not mutually transmit and receive the control data, the first video processing unit 10 calculates the brightness distribution data on the basis of only the control data about the first region. Likewise, the second video processing unit 20 calculates the brightness distribution data on the basis of only the control data about the second region. Hence, the brightness distribution data exhibits no bright regions in the first region and exhibits a bright region in only the second region, as illustrated in FIG. 6(f) and FIG. 6(g).

As illustrated in FIG. 6(h), the brightness of the light from the LEDs diffuses not only into a region corresponding to the LEDs, but also into its surrounding regions. Hence, the actual brightness distribution in the backlight 110 exhibits a high-brightness region in the first region as well due to the brightness of the LEDs in the second region, as illustrated in FIG. 6(i). Unfortunately, the brightness distribution data calculated in the comparative display device exhibits no such regions and has low accuracy.

In the display device 1 in contrast, the first video processing unit 10 and the second video processing unit 20 mutually transmit and receive the control data. The first video processing unit 10 thus calculates brightness distribution data affected by the control data about the second region. The brightness distribution data consequently exhibits a high-brightness region in the first region due to the LEDs in the second region of the backlight, as illustrated in FIG. 6(j). As a result, the display device 1 improves the accuracy of the brightness distribution data. Furthermore, calculating the display data using the brightness distribution data can improve the accuracy of the local dimming.

### Effects

As described above, the display device 1 is configured such that only the first video processing unit 10 outputs, to the brightness controlling circuit 111, the control data for controlling the regions of the backlight 110 corresponding to the whole regions of the input video. This configuration requires no components for integrating the pieces of control data together, calculated by the respective first video processing unit 10 and second video processing unit 20, thereby saving the costs for manufacturing the display device 1.

In the display device 1, the display-data calculators 14 and 24 calculate the display data on the basis of brightness distribution in the regions of the backlight 110 corresponding to the entire input video. The display-data calculators 14 and 24 hence calculate brightness distribution data by referring not only to the brightness of the LEDs that are included in their target regions, but also to the brightness of the LEDs that are not included in their target regions and affects the brightness distribution in their target regions. The display device 1 consequently improves the accuracy of the local dimming.

It is noted that in one aspect of the present disclosure, the display device 1 may be configured such that the display panel 109 and backlight 110 are separated from the other components. In this case, one of the components of the display device 1 other than the display panel 109 and the backlight 110, to be specific, an apparatus that includes components, such as the first video processing unit 10 and the second video processing unit 20, serves as a video processor.

It is also noted that in addition to the foregoing local dimming, the first video processing unit 10 and the second video processing unit 20 may perform processing, such as color-tone correction and frame-rate increase/decrease.

### Second Embodiment

Another embodiment of the present disclosure will be described.

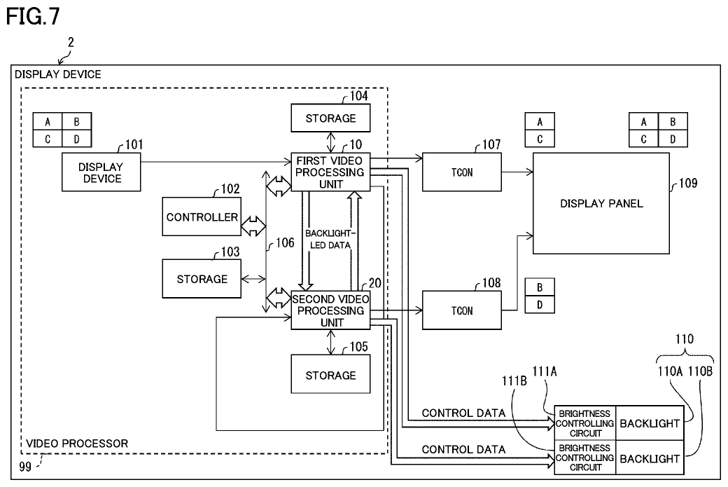

FIG. 7 is a block diagram illustrating the configuration of a display device 2 according to this embodiment. The display device 2 is different from the display device 1 in that the divided regions of the backlight 110 are sectioned into a first set 110A and a second set 110B. The first set 110A is located in a region of the backlight 110 corresponding to the regions A and B of an input video. The second set 110B is located in a region of the backlight 110 corresponding to the regions C and D of the input video. Moreover, the backlight 110 includes a first brightness controlling circuit 111A and a second brightness controlling circuit 111B. The first brightness controlling circuit 111A controls the brightness of the divided regions included in the first set 110A. The second brightness controlling circuit 111B controls the brightness of the divided regions included in the second set 110B. That is, the first brightness controlling circuit 111A drives LEDs disposed in the upper-half region of the backlight 110. The second brightness controlling circuit 111B drives LEDs disposed in the lower-half region of the backlight 110.

The display device 2 is configured such that the first video processing unit 10 performs video processing on the left-half region of the backlight 110 (i.e., a region corresponding to the regions A and C of the input video). The display device 2 is also configured such that the second video processing unit 20 performs video processing on the right-half region of the backlight 110 (i.e., a region corresponding to the regions B and D of the input video). The display device 2 is further configured such that the first video processing unit 10 and the second video processing unit 20 mutually transmit and receive control data.

In the display device 2, the control data needs to be transmitted to each of the first brightness controlling circuit 111A and the second brightness controlling circuit 111B. For instance, the first video processing unit 10 transmits the pieces of control data corresponding to the divided regions to be controlled by the respective circuits, to the respective first brightness controlling circuit 111A and second brightness controlling circuit 111B. Alternatively, the second video processing unit 20 transmits the pieces of control data corresponding to the divided regions to be controlled by the respective circuits, to the respective first brightness controlling circuit 111A and second brightness controlling circuit 111B.

Consequently in the display device 2, the divided regions of the backlight 110 controlled by the control data transmitted by the first video processing unit 10 (i.e., a region corresponding to the regions A and B) and the divided regions of the backlight 110 corresponding to a partial video region (i.e., a region corresponding to the regions A and C) processed by the first video processing unit 10 are different from each other. Likewise, the divided regions of the backlight 110 controlled by the control data transmitted by the second video processing unit 20 (i.e., a region corresponding to the regions C and D) and the divided regions of the backlight 110 corresponding to the partial video region (i.e., a region corresponding to the regions B and D) processed by the second video processing unit 20 are different from each other.

The backlight 110 is preferably designed to be divided into multiple sets, depending on the configuration of a power source of the display device and the configuration of a substrate of the display device. The display device 2 is a display device having such a power-source configuration and such a substrate configuration, in which the backlight 110 is divided into the upper and lower parts. The video processor in the present disclosure is usable in such a display device 2.

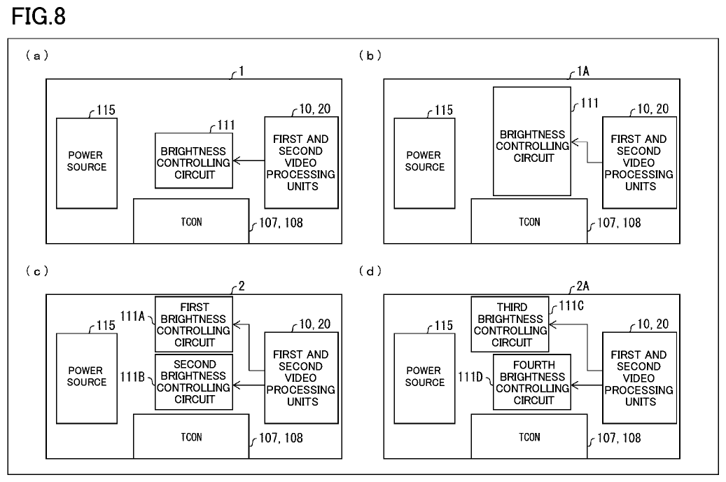

With reference to FIG. 8(a) to FIG. 8(d), the following describes an example of substrate placement in the display device. FIG. 8(a) to FIG. 8(d) show a power source 115. The power source 115 is a power-source substrate that supplies power to the display device.

FIG. 8(a) illustrates an example of the substrate placement in the display device 1. In the display device 1, the single brightness controlling circuit 111 is near the middle of the display device 1, as illustrated in FIG. 8(a). For dividing the backlight 110 into multiple sets, the brightness controlling circuit 111 needs to be designed in a manner different from that illustrated in FIG. 8(a).

FIG. 8(b) illustrates the configuration of a display device 1A, which is an exemplary display device in which the backlight 110 has an increased number of divided regions. In the display device 1A, the size of the brightness controlling circuit 111 per se is enlarged as illustrated in FIG. 8 (b). The brightness controlling circuit 111 in this case can be designed optimally in conformance with the number of divided regions in the display device 1A and with other things.

FIG. 8(c) illustrates an example of the substrate placement in the display device 2. In the example in FIG. 8(c), the first brightness controlling circuit 111A controls the upper half of the backlight, and the second brightness controlling circuit 111B controls the lower half of the same. In this case, the display device 2 is manufactured at lower cost than the display device 1A is, because a conventional circuit can be used as the first brightness controlling circuit 111A and as the second brightness controlling circuit 111B.

FIG. 8(d) illustrates an example of the substrate placement in a display device 2A, which is a modified version of the display device 2. The display device 2A is different from the display device 2 in that the display device 2A includes a third brightness controlling circuit 111C and a fourth brightness controlling circuit 111D instead of the first brightness controlling circuit 111A and the second brightness controlling circuit 111B. The third brightness controlling circuit 111C controls LEDs included in the left-half divided region of the backlight 110. The fourth brightness controlling circuit 111D controls LEDs included in the right-half divided region of the backlight 110. An advantage of the display device 2A versus that of the display device 1A is generally similar to the advantage of the display device 2.

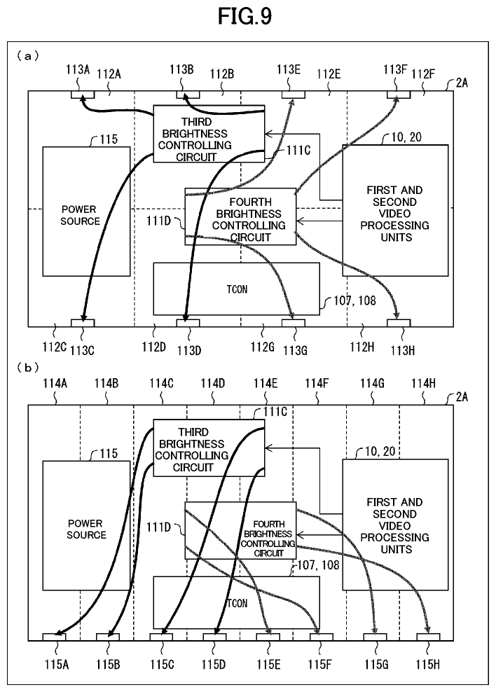

FIG. 9(a) illustrates exemplary wiring in the display device 2A. In the example in FIG. 9(a), the display device 2A includes a backlight having eight LED substrates 112A to 112H arranged in two columns and four rows. The LED substrates 112A to 112D are on the left side of the display device 2A, and the LED substrates 112E to 112H are on the right side of the same. Moreover, the LED substrates 112A to 112H include input terminals 113A to 113H in a location corresponding to the upper or lower end of the display device 2A. The input terminal 113A to 113H each receive a signal line from the third brightness controlling circuit 111C or fourth brightness controlling circuit 111D.

FIG. 9(b) illustrates different exemplary wiring in the display device 2A. In the example in FIG. 9(b), the display device 2A includes a backlight having eight LED substrates 114A to 114H arranged in a row. The LED substrates 114A to 114D are on the left side of the display device 2A, and the LED substrates 114E to 114H are on the right side of the same. Moreover, the LED substrates 114A to 114H include input terminals 115A to 115H in a location corresponding to the lower end of the display device 2A. The input terminals 115A to 115H each receive a signal line from the third brightness controlling circuit 111C or fourth brightness controlling circuit 111D.

FIG. 9(a) and FIG. 9(b) each show bold arrows denoting wires extending from the third brightness controlling circuit 111C or fourth brightness controlling circuit 111D to the input terminals 113A to 113H or 115A to 115H. When one of the third brightness controlling circuit 111C and fourth brightness controlling circuit 111D is not placed on the right or left, the wires from the third brightness controlling circuit 111C or fourth brightness controlling circuit 111D easily interfere with the other substrates (i.e., the first video processing unit 10, the second video processing unit 20, the TCONs 107 and 108, the other one of the third brightness controlling circuit 111C and fourth brightness controlling circuit 111D, and the power source 115), as illustrated in FIG. 9(a) and FIG. 9(b).

For this reason, it is preferable to include the first brightness controlling circuit 111A and the second brightness controlling circuit 111B, which respectively control the upper and lower halves of the backlight, like the display device 2 in FIG. 8(c).

### Third Embodiment

Another embodiment of the present disclosure will be described.

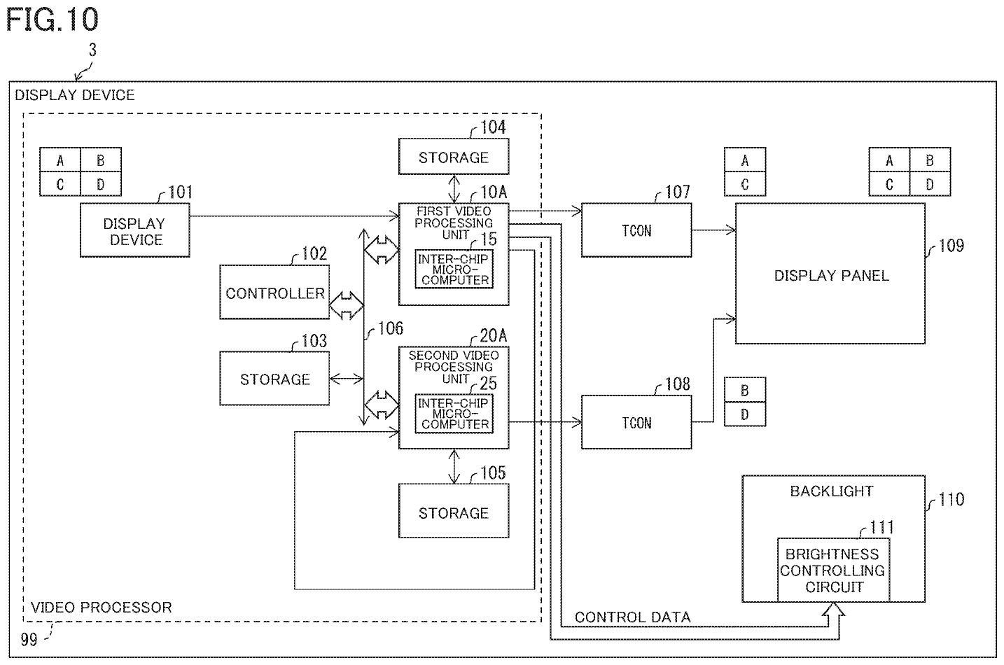

FIG. 10 is a diagram illustrating the configuration of a display device 3 according to this embodiment. As illustrated in FIG. 10, the display device 3 is different from the foregoing display devices in that the display device 3 includes a first video processing unit 10A and a second video processing unit 20A instead of the first video processing unit 10 and the second video processing unit 20. The first video processing unit 10A includes a transmission-and-reception controller 15 in addition to the configuration of the first video processing unit 10. The second video processing unit 20A includes a transmission-and-reception controller 25 in addition to the configuration of the second video processing unit 20.

The transmission-and-reception controller 15 controls the first video processing unit 10A to transmit and receive control data. The transmission-and-reception controller 25 controls the second video processing unit 20A to transmit and receive control data. In other words, the first video processing unit 10A transmits and receives the control data to and from the second video processing unit 20A via the transmission-and-reception controller 15, and the second video processing unit 20A transmits and receives the control data to and from the first video processing unit 10A via the transmission-and-reception controller 25.

Such a display device 3 has an effect similar to that of the display device 1.

### Fourth Embodiment

Another embodiment of the present disclosure will be described.

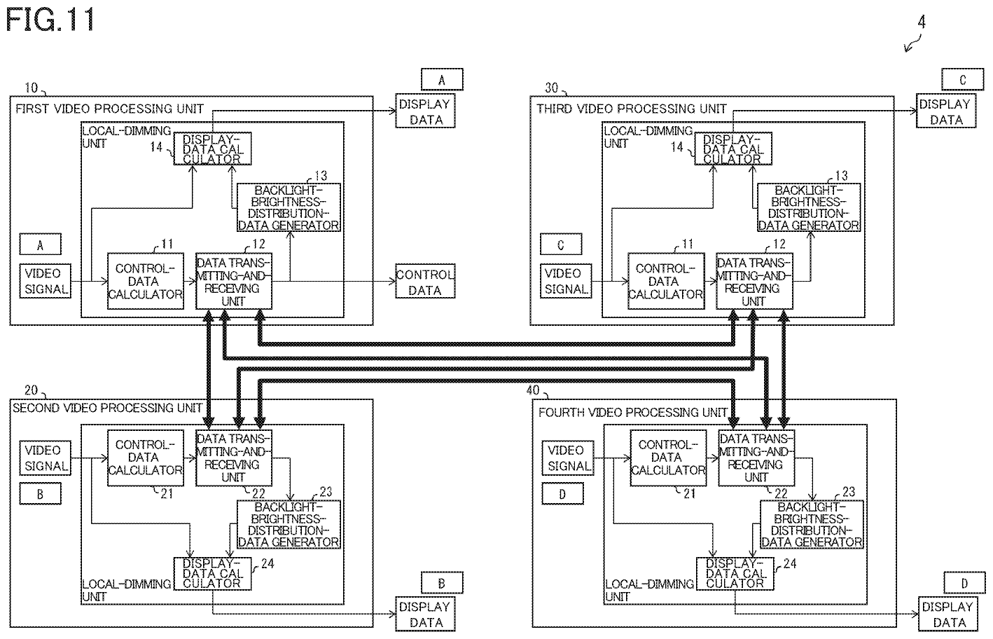

FIG. 11 is a diagram illustrating the configuration of main components of a display device 4 according to this embodiment. As illustrated in FIG. 11, the display device 4 further includes a third video processing unit 30 and a fourth video processing unit 40 in addition to the configuration of the display device 1.

In the display device 4, the first video processing unit 10, the second video processing unit 20, the third video processing unit 30, and the fourth video processing unit 40 respectively perform video processing on the region A, the region B, the region C, and the region D (i.e., the respective four divided 4K videos of an 8K video or input video). The first video processing unit 10 to the fourth video processing unit 40 mutually transmit and receive control data at this time. Each of the first video processing unit 10 to the fourth video processing unit 40 accordingly calculates brightness distribution data on the basis of control data for controlling all the divided regions of the backlight 110. Such a configuration improves the accuracy of local dimming when compared to a configuration where the first video processing unit 10 to the fourth video processing unit 40 do not mutually transmit and receive the control data.

In the display device 4, only the first video processing unit 10 transmits the control data for controlling all the divided regions of the backlight 110 to the brightness controlling circuit 111. Such a configuration requires no components for integrating the pieces of control data together, generated by the multiple video processing units.

The foregoing example has described that the first video processing unit 10 to the fourth video processing unit 40 mutually transmit and receive the control data. In the display device 4 however, each of the first video processing unit 10 to the fourth video processing unit 40 does not necessarily transmits and receives the control data to and from all the other video processing units. Each of the first video processing unit 10 to the fourth video processing unit 40 needs to transmit and receive the control data to acquire the control data about all the divided regions of the backlight 110.

For instance, the first video processing unit 10 may receive the control data from each of the second video processing unit 20 to the fourth video processing unit 40 and then transmit the control data to each of the second video processing unit 20 to the fourth video processing unit 40. In this case, the second video processing unit 20 to the fourth video processing unit 40 transmit and receive the control data to and from only the first video processing unit 10, whereas the first video processing unit 10 transmits and receives the control data to and from all the second video processing unit 20 to the fourth video processing unit 40.

Such a display device 4, which includes four video processing units (i.e., the first video processing unit 10 to the fourth video processing 40), is also included in an embodiment of the present disclosure. Furthermore, a display device according to an aspect of the present disclosure may include any number of video processing units other than two or four.

### Fifth Embodiment

Another embodiment of the present disclosure will be described.

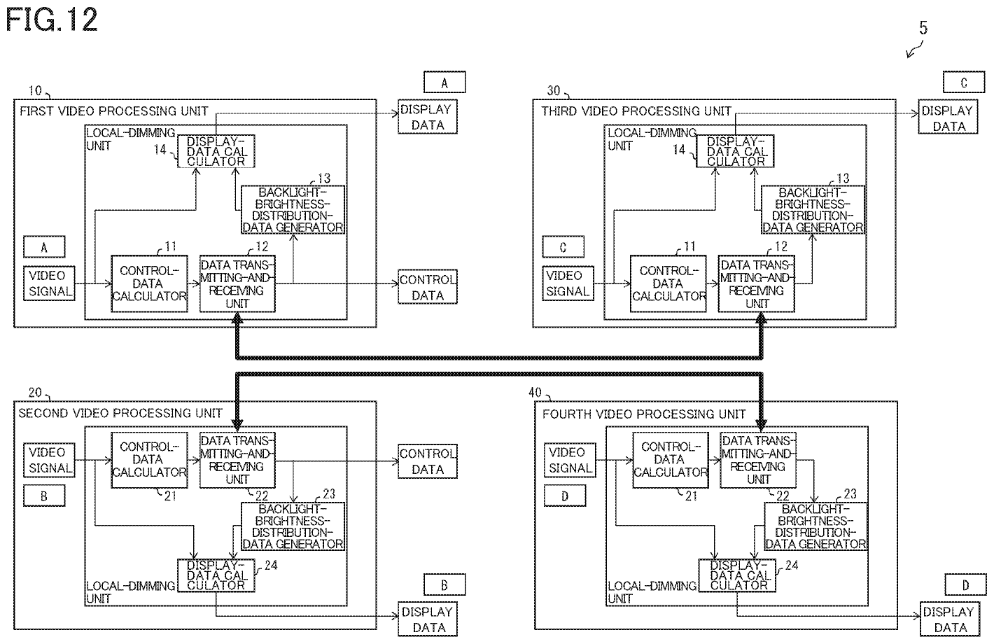

FIG. 12 is a diagram illustrating the configuration of main components of a display device 5 according to this embodiment. As illustrated in FIG. 12, the display device 5 includes the first video processing unit 10 to the fourth video processing unit 40, like the configuration of the display device 4.

The display device 5 includes brightness controlling circuits corresponding to the respective two divided upper and lower regions of the backlight 110, like the display device 2. In this case, (i) one of the first video processing unit 10 second video processing unit 20 and (ii) one of the third video processing unit 30 and fourth video processing unit 40 transmit control data to the respective two brightness controlling circuits. Such a display device 5 is also included in one aspect of the present disclosure.

In the display device 5, at least (i) the first video processing unit 10 and second video processing unit 20 and (ii) the third video processing unit 30 and fourth video processing unit 40 mutually transmit and receive the control data, as illustrated in FIG. 12. This configuration improves the accuracy of pieces of brightness distribution data, calculated by the respective first video processing unit 10 to fourth video processing unit 40, when compared to a configuration where these processing units do not mutually transmit and receive the control data. To further improve the accuracy of these pieces of brightness distribution data, the display device 5 is preferably configured such that each of the first video processing unit 10 to the fourth video processing unit 40 acquires control data corresponding to all the divided regions of an output video.

### Sixth Embodiment

Another embodiment of the present disclosure will be described.

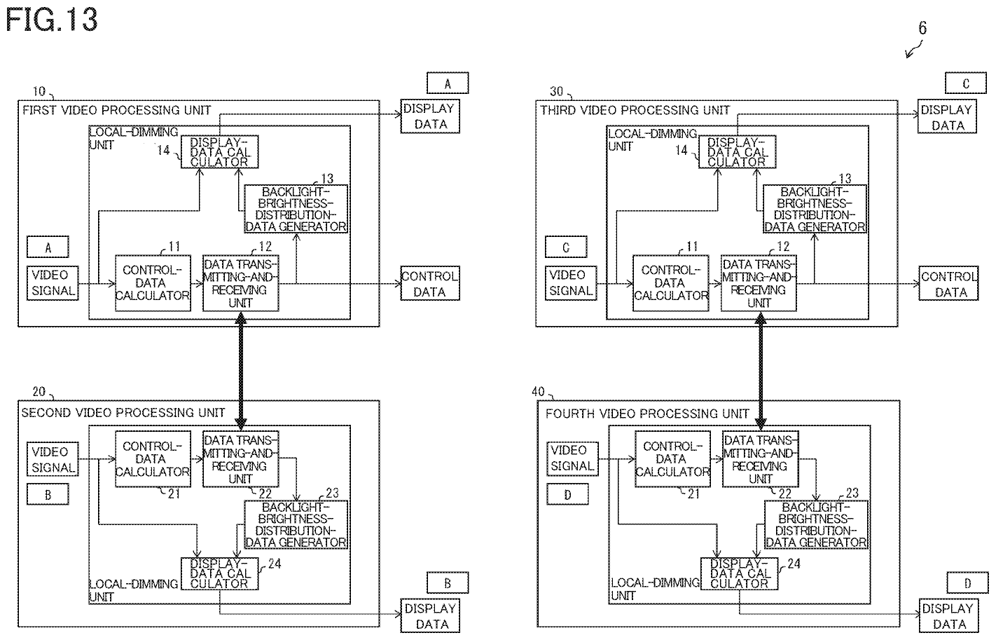

FIG. 13 is a diagram illustrating the configuration of main components of a display device 6 according to this embodiment. As illustrated in FIG. 13, the display device 6 includes the first video processing unit 10 to the fourth video processing unit 40, like the configuration of the display device 4.

Unlike the display device 2, the display device 6 includes two brightness controlling circuits corresponding to the respective two divided right and left regions of the backlight 110. In this case, (i) one of the first video processing unit 10 and third video processing unit 30 and (ii) one of the second video processing unit 20 and fourth video processing unit 40 transmit control data to the respective two brightness controlling circuits.

In the display device 6, at least (i) the first video processing unit 10 and third video processing unit 30 and (ii) the second video processing unit 20 and fourth video processing unit 40 mutually transmit and receive the control data, as illustrated in FIG. 13. This configuration improves the accuracy of pieces of brightness distribution data, calculated by the respective first video processing unit 10 to the fourth video processing unit 40, when compared to a configuration where these processing units do not mutually transmit and receive the control data. To further improve the accuracy of these pieces of brightness distribution data, the display device 6 is preferably configured such that each of the first video processing unit 10 to the fourth video processing unit 40 acquires control data corresponding to all the divided regions of an output video.

Examples Implemented by Software

The control blocks of the display device 1 and of the other devices (in particular, the control-data calculator 11, the data transmitting-and-receiving unit 12, the backlight-brightness-distribution-data generator 13, the display-data calculator 14, the control-data calculator 21, the data transmitting-and-receiving unit 22, the backlight-brightness-distribution-data generator 23, and the display-data calculator 24) may be implemented by a logic circuit (i.e., hardware) installed in an integrated circuit (i.e., IC chip) or may be implemented by software.

For software, the display device 1 and the other devices each include a computer that executes commands of a program or software that implements the individual functions. This computer includes, but not limited to, at least one processor (i.e., controller) and at least one computer-readable recording medium storing the program. In the computer, the processor reads the program from the recording medium and executes the program, thereby achieving the object of the present disclosure. An example of the processor usable herein is a central processing unit (CPU). An example of the recording medium usable herein is a non-transitory tangible medium, including a read only memory (ROM), a tape, a disk, a card, a semiconductor memory, and a programmable logic circuit. The computer may further include, for instance, a random access memory (RAM) that develops the program. The program may be supplied to the computer via any transmission medium (such as a communication network or a broadcast wave) that can transmit the program. An aspect of the present disclosure can be also achieved in the form of a data signal embodied by electronic transmission of the program and embedded in a carrier wave.

The present disclosure is not limited to the foregoing embodiments and can be modified in various ways within the scope of the claims. In addition, an embodiment obtained in combination, as appropriate, with the technical means disclosed in the individual embodiments is also included in the technical scope of the present disclosure. Furthermore, combining the technical means in the individual embodiments can form a new technical feature.

### CROSS-REFERENCE TO RELATED APPLICATION

The present application claims priority from Japanese Application No. 2018-032325, filed Feb. 26, 2018, the content of which is incorporated herein by reference in its entirety.

### REFERENCE SIGNS LIST

1, 1A, 2, 2A, 3, 4, 5, 6 display device
10 first video processing unit
20 second video processing unit
30 third video processing unit
40 fourth video processing unit
110 backlight
110A first set
110B second set
111A first brightness controlling circuit
111B second brightness controlling circuit
111C third brightness controlling circuit
111D fourth brightness controlling circuit

1. A video processor included in a display device that includes a backlight having a plurality of divided regions, the video processor comprising:
a first video processing unit configured to perform video processing on a partial video region that is a partial region of an input video; and
a second video processing unit configured to perform video processing on a region different from the partial video region,
wherein the first video processing unit transmits control data for controlling the plurality of divided regions of the backlight to the backlight, and
the plurality of divided regions of the backlight controlled by the control data, which is transmitted by the first video processing unit, and the plurality of divided regions of the backlight corresponding to the partial video region, which is processed by the first video processing unit, are different from each other.

2. The video processor according to claim 1, wherein the first video processing unit transmits control data for controlling all the plurality of divided regions of the backlight to the backlight.

3. The video processor according to claim 1, wherein
for the partial video region, the first video processing unit generates the control data for controlling the plurality of divided regions of the backlight corresponding to the partial video region,
for the region different from the partial video region, the second video processing unit generates the control data for controlling the plurality of divided regions of the backlight corresponding to the region different from the partial video region, and
the first and second video processing units mutually transmit and receive the control data.

4. The video processor according to claim 1, wherein
the backlight comprises a brightness controlling circuit configured to control a brightness of each of the plurality of divided regions, and
the first video processing unit transmits the control data to the brightness controlling circuit.

5. The video processor according to claim 1, wherein
the plurality of divided regions are at least sectioned into a first set and a second set,
the backlight comprises
a first brightness controlling circuit configured to control a brightness of the plurality of divided regions included in the first set, and
a second brightness controlling circuit configured to control a brightness of the plurality of divided regions included in the second set, and
the first video processing unit transmits, to the first brightness controlling circuit, the control data corresponding to the plurality of divided regions that are targets for the first brightness controlling circuit, and the first video processing unit transmits, to the second brightness controlling circuit, the control data corresponding to the plurality of divided regions that are targets for the second brightness controlling circuit.

6. A display device comprising:
a display panel configured to display an output video;
a backlight comprising a plurality of divided regions; and
the video processor according to claim 1.

7. The display device according to claim 6, wherein the backlight comprises a plurality of light-emitting units configured to cast light upon the display panel.

8. A method of video processing performed in a video processor included in a display device that includes a backlight having a plurality of divided regions,
the video processor including
a first video processing unit that performs video processing on a partial video region that is a partial region of an input video, and
a second video processing unit that performs video processing on a region different from the partial video region,
the method comprising the steps of:
performing, in the first video processing unit, video processing on the partial video region and performing, in the second video processing unit, video processing on the region different from the partial video region; and
transmitting control data for controlling the plurality of divided regions of the backlight to the backlight, the transmitting step being performed in the first video processing unit,
wherein the plurality of divided regions of the backlight controlled by the control data, which is transmitted by the first video processing unit, and the plurality of divided regions of the backlight corresponding to the partial video region, which is processed by the first video processing unit, are different from each other.

9. A non-transitory computer-readable recording medium storing a program for operating a computer as the video processor according to claim 1, the program causing the computer to function as the first and second video processing units.

10. (canceled)
